(19) United States
(12) Patent Application Publication
(10) Pub. No.: US 2013/0087544 A1
(43) Pub. Date: Apr. 11, 2013

(54) ARTICLE OF CLOTHING COMPRISING AN OPERATING PART

(71) Applicant: THERM-IC PRODUCTS GMBH NFG. & CO. KG, Gleisdorf (AT)

(72) Inventors: GERHARD KREMER, Fuerstenfeld (AT); Urs Maron, Haselsdorf-Tobelbad (AT)

(73) Assignee: THERM-IC PRODUCTS GMBH NFG. & CO. KG, Gleisdorf (AT)

(21) Appl. No.: 13/645,547

(22) Filed: Oct. 5, 2012

Related U.S. Application Data
(60) Provisional application No. 61/544,392, filed on Oct. 7, 2011.

(51) Int. Cl. H05B 3/00

(52) U.S. Cl. CPC H05B 3/00
USPC 219/211

(57) ABSTRACT

An article of clothing, comprising an operating part for manually operating a controllable device which can be connected to the article of clothing by means of at least one operating element of the operating part, wherein the operating part comprises a first molding, which is rigidly connected to the article of clothing and which comprises the at least one operating element, and a second molding, which comprises a holder for a control unit of the device and can be connected to the first molding, wherein the first molding comprises at least one first retaining element and the second molding comprises at least one second retaining element, wherein the two retaining elements can be brought in mutual engagement with each other so as to establish a detachable connection between the first molding and the second molding.

### RELATED APPLICATION

This application claims the benefit, under 35 U.S.C. 119(e), of the provisional application filed Oct. 7, 2011 under 35 U.S.C. 111(b), which was granted Ser. No. 61/544,392. This provisional application is hereby incorporated by reference.

### BACKGROUND OF THE INVENTION

The invention, relates to an article of clothing, and more specifically to an article of clothing comprising controllable devices.

Such articles of clothing of the type in question comprising controllable devices are known from the published prior art WO 2009/092618 A1. This document describes such an article of clothing in one embodiment in the form of a glove comprising a heating device. An article of clothing of the type in question comprises an operating part having one or more operating elements, such as one or more push buttons, for example, so as to manually operate the controllable device thereof. A control unit of the device can be operated via the at least one operating element so as to set control parameters for controlling the device, such as desired heating output, for example.

As described in the published prior art WO 2009/092618 A1, this control unit may comprise a printed circuit board having an electric control circuit, for example, which can, for example, be equipped to control the temperature of a heat transfer element of the device.

So as to protect the control unit from outside influences, according to the prior art the control unit is disposed inside an encapsulation of the operating part which is rigidly connected to the article of clothing. While such an operating part allows a device of an article of clothing to be conveniently operated, cleaning such articles of clothing has proven to be problematic. This is because of the risk of water or detergent entering the operating part when cleaning the article of clothing and damaging the control unit. Especially the site at which a control line passes through the encapsulation of the control unit for transmitting control signals from the control unit to the device represents a weak point in this regard, because leaks can easily develop at this site in particular.

It is thus the object of the present invention to provide an article of clothing comprising an operating part for manually operating a controllable device which can be connected to the article of clothing and which overcomes the drawbacks of the prior art. Such an article of clothing should thus be easy to clean, without any risk of damaging the control unit of the device, for example by liquids entering the operating part and the control unit.

### SUMMARY OF THE INVENTION

This object is achieved according to the invention by an article of clothing according to the main claim. Refinements and special embodiments of the invention are the subject matter of the dependent claims.

In an article of clothing according to the invention comprising an operating part for manually operating a controllable device which can be connected to the article of clothing by means of at least one operating element of the operating part, the operating part comprises a first molding, which is rigidly connected to the article of clothing and comprises that at least one operating element. The operating part further comprises a second molding, which has a holder, such as a depression or a compartment, for example, for a control unit of the device and which can be connected to the first molding.

It is essential for the invention that the first molding comprises at least one retaining element and that the second molding comprises at least one second retaining element, wherein the two retaining elements can be brought into mutual engagement so as to establish a detachable connection between the first molding and the second molding. As soon as the two moldings are connected to each other by means of these retaining elements, the second molding is also connected to the article of clothing by being held by means of the retaining elements on the first molding which is rigidly connected to the article of clothing, for example by means of sewing. After the mutual engagement of the retaining elements has been detached, the second molding can be detached and removed from the first molding, and thus also from the article of clothing.

The control unit may also be encapsulated by the first and second moldings and can be securely fixed and protected from outside influences when the first and second moldings are connected to each other. The two moldings then form an encapsulation for the control unit, however the encapsulation can be opened easily and without difficulty, for example so as to remove the control unit or replace it with another one.

For example, one of the at least one first retaining elements can be designed as a brim that preferably extends completely around the first molding. However, it is also possible for one of the at least one second retaining elements to be designed as a brim extending completely around the second molding. It is likewise possible for one of the at least one first retaining elements to be designed as an outer edge of the first molding or for one of the at least one second retaining elements to be designed as an outer edge of the second molding. What is decisive for the special embodiment of the aforementioned retaining elements is that these can engage with each other such that a detachable positive-fit connection is established between the first molding and the second molding when the engagement exists. This can be done, for example, in that the at least one first (or second) retaining element latches over the at least one second (or first) retaining element as soon as and as long as such a connection-between the two moldings exists.

So as to establish or detach such a connection between the two moldings, according to the invention first at least one of the retaining elements, or all retaining elements, are moved out of a respective equilibrium position, so as to establish or detach the positive fit and the engagement between the retaining elements.

If a control unit of a device that can be or is connected to the article of clothing is located in the holder of the second molding, the control unit can be separated without difficulty from the article of clothing by detaching the engagement between the two retaining elements and by detaching the connection between the first and second moldings, for example so as to then be able to clean or wash the article of clothing. It is thus also possible, of course, to replace the control unit with another control unit, for example in the event the control unit is defective. The control unit can possibly be connected to the device via at least one electrical wire, such as a control line for transmitting control signals, for example, as will be described in more detail hereafter. At least one plug connection can then additionally be provided in order to establish and detach a connection between the at least one line and the device and/or between the line and the control unit.

According to one refinement, the holder of the second molding for the control unit is designed as a depression in the second molding. This depression can, for example, be covered by a protective film or a protective cover. A control unit located in the depression can thus be protected from outside influences, for example from moisture, splashing water, dirt or mechanical effects. In addition, such a protective film or such a protective cover can prevent the control unit from inadvertently detaching from the second molding and potentially being lost. On the whole, such a protective film or such a protective cover can thus assure particularly secure storage of the control unit, for example during cleaning of the article of clothing or during replacement of the control unit.

According to one refinement, the first molding has a flange-shaped first edge region and the second molding has a flange-shaped second edge region. When and as soon as the two moldings are connected to each other (by the aforementioned mutual engagement of the retaining elements of the two moldings), these flange-shaped edge regions rest on top of each other in a planar manner and extend completely, which is to say without interruptions, around the holder for the control unit. The two edge regions are preferably additionally pressed against each other by a permanent pressing force which is generated by the two retaining elements. Such planar seating on top of each other, and optionally pressing against each other, of the two flange-shaped edge regions causes particularly secure sealing of the holder of the control unit, so that the same is protected particularly reliably, for example from entering liquid. So as to generate the aforementioned pressing force, all or at least some of the retaining elements are designed to be elastic. For this purpose, the retaining elements in question can be produced from a flexible and permanently elastic plastic material, such as a silicone, for example. Materials that can be used for the operating part, and more particularly for the first and/or second moldings and/or the retaining elements of the first and/or second moldings include all castable, pressable, extrudable, moldable and/or blow-moldable materials, such as thermoplastic elastomers (TPE), thermoplastic (poly)urethanes (TPU), and rubber-like materials. The parts in question can thus be cast, pressed, extruded, molded or blow-molded from these materials. It is also possible, of course, to produce the first and/or second moldings entirely from such a permanently elastic material. The aforementioned protective film and the aforementioned protective cover can likewise be produced from an elastic material, for which the above-mentioned materials may also be used. The use of (permanently) elastic materials can additionally increase the wearing comfort of the operating part and of the article of clothing. By using elastic materials, it is also possible for the connection between the first molding and the second molding to be established particularly easily and to be detached again.

According to one refinement, the second molding has a hole for passing the aforementioned electrical wires, such as the control line, for example, through the second molding. It can thus be prevented that the aforementioned wires must be passed through an interface or a boundary region between the first and second moldings, whereby the risk of leaks between the first and second moldings is reduced.

The risk of leaks can also be reduced by means of additional sealing elements, which preferably have an annular design and preferably extend completely around the receiving region for the control unit. Such a sealing element can, for example, be designed in form of a rib on one of the two moldings or by a separate sealing ring.

According to one refinement, the molding is designed to be transparent at least regionally, which is to say it is made of a transparent material at least in one region, so as to allow a display of the control unit to be viewed through the first molding. For this purpose, the aforementioned protective film or the aforementioned protective cover can be entirely or at least regionally transparent, or produced from a transparent material.

In a special embodiment, the device of the article of clothing is a heating device, as that which is described in the published prior art WO 2009/092618 A1 mentioned above.

In addition, the control unit may comprise at least one input interface for manually inputting control parameters in the control unit, wherein the at least one input interface of the control unit is placed on an upper face of the control unit such that the at least one input interface can be operated by means of the at least one input element of the first molding when and as soon as the two moldings are connected to each other by the aforementioned mutual engagement of the retaining elements of the two moldings. In the described example of the device being a heating device, two input interfaces can be provided, which can be operated by means of two input elements of the first molding, wherein a first of the two input interfaces is used to increase a heating output and the second of the two input interfaces is used to reduce a heating output. To this end, the control unit is equipped to actuate the heating device for delivering this heating output, depending on the heating output that is selected. Reference is again made to the published prior art WO 2009/092618 A1 for a special embodiment of these input elements and input interfaces.

So as to transmit control signals, the control unit can be connected to the device via the aforementioned at least one control line, wherein a first end of the control line is connected to the control unit and a second end of the control unit is connected to the device. In one embodiment, the at least one control line has a two-part design, wherein a first part of the control line is connected to the control unit and a second part of the control line is connected to the device. Both parts have a respective plug element for connecting the two parts to the control line. When the control unit is removed from the article of clothing, the two parts of the at least one control line can then be separated by means of the two plug elements, so that the first part of the control line remains connected to the control line and the second part of the control line remains connected to the device which is connected to the article of clothing.

The two parts of the control line can accordingly be re-connected to each other by means of these plug elements as soon as the control unit is to be re-connected to the article of clothing. It is also possible to dispose connecting devices for control lines directly on the controllable device and/or on the second molding, so that the at least one control line can be connected to the device or to the control unit via such connecting devices, such as connectors or sockets. The article of clothing shall, in general, be understood to mean a garment or a blanket, a pillow or a sleeping bag. However, the article of clothing can also be part of such a garment The article of clothing can thus be, for example, a jacket, pants, a shoe, a glove, a sock or a cap, or part of a jacket, pants, a shoe, a glove, a sock or a cap. For example, the article of clothing can also be an insole of a shoe or an inner or outer shell of a shoe, a jacket or pants.

### BRIEF DESCRIPTION OF THE DRAWINGS

The invention will be described in more detail hereafter based on a special exemplary embodiment shown schematically in FIGS. 1 to 10c. In the drawings:

FIG. 1 shows an article of clothing of the type that is proposed here, comprising an operating part for manually operating a controllable heating device that is connected to the article of clothing;

FIGS. 2 to 4b show various views of a first molding of an operating part of an article of clothing of the type that is proposed here;

FIGS. 5a to 8 show various views of a second molding of an operating part of an article of clothing of the type that is proposed here;

FIG. 9 is an individual view of the protective cover shown in FIG. 8; and

FIGS. 10a to 10c show a first molding and a second molding of an operating part of an article of clothing of the type that is proposed here before and after the positive-fit connection between the two moldings is established.

Recurring characteristics are denoted by the same reference numerals.

### DETAILED DESCRIPTION OF THE INVENTION

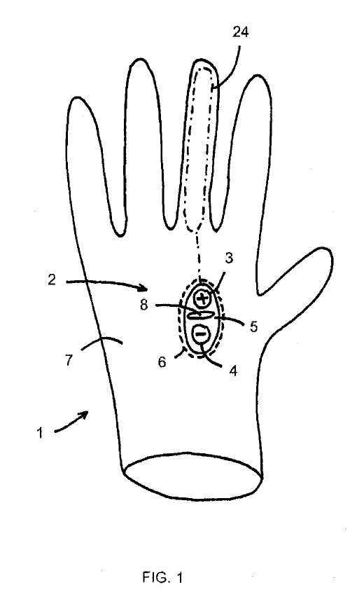

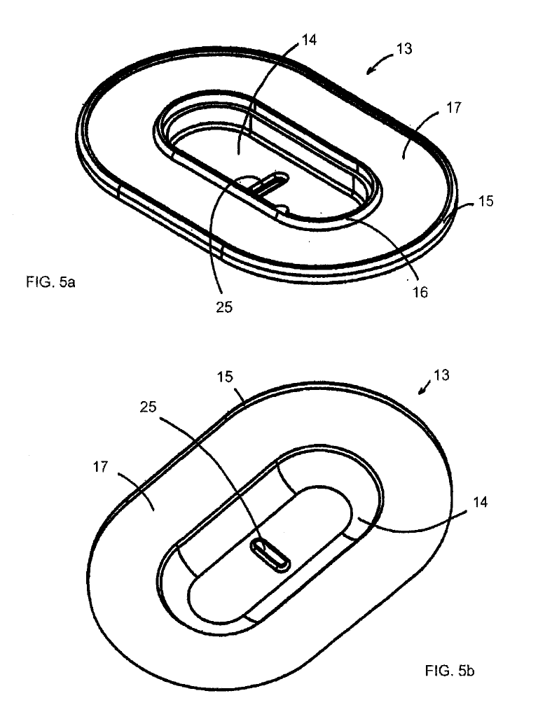

FIG. 1 shows a schematic illustration of a special exemplary embodiment of an article of clothing 1 of the type that is proposed here. The article of clothing 1 is a glove, comprising an operating part 2 for manually operating a controllable heating device 24 which is connected to the article of clothing 1 by means of a first and a second operating element 3, 4. The heating device 24 is only schematically indicated inside the article of clothing 1 by a dot-and-dashed line to provide better clarity. Reference is made here to the prior art, for example to the published prior art WO 2009/092618 A1, with regard to details for possible embodiments of the heating device 24. The two operating elements 3, 4 are disposed on the first molding 5 of the operating part, which is rigidly connected to an outer shell 7 of the article of clothing 1 by means of a seam 6 and comprises a transparent region 8 through which a display of a control unit is visible, refer to FIG. 6.

The article of clothing 1 shown could also be a jacket, pants, a shoe, a sock, a cap or another garment. The article of clothing, however, could also be a blanket, a pillow or a sleeping bag.

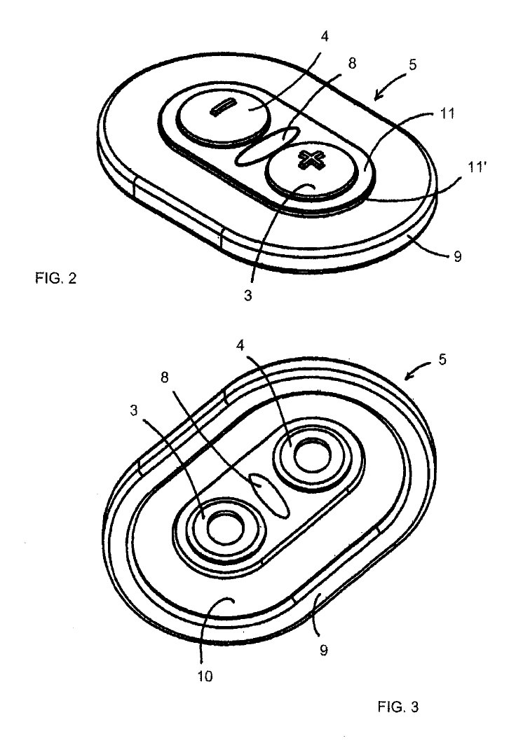

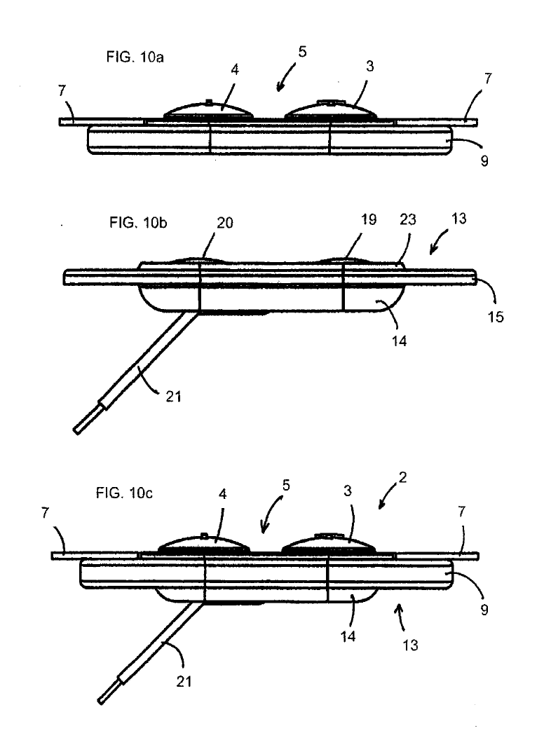

FIG. 2 shows a schematic illustration of a first molding 5 of an operating part of an article of clothing of the type that is proposed here. This could be, for example, the first molding 5 shown in FIG. 1. A first and a second operating element 3 and 4 are clearly apparent, which are designed as push buttons having flexible shapes and which can be pressed in by manual operation, for example so as to set control parameters of a control unit which can be disposed directly beneath the operating elements 3, 4, refer to FIGS. 10a-10c. A transparent region 8, through which a display of such a control unit is visible, is disposed between the two operating elements 3, 4.

The shown first molding 5 comprises a first retaining element 9 in the form of a collar, which extends completely around the first molding 5. The first molding 5 is produced entirely from an elastic material, which in this example is silicone.

FIG. 3 is a schematic illustration of the first molding 5 shown in FIG. 2 in a view obliquely from beneath. Especially the lower faces of the two operating elements 3, 4 and the transparent region 8 are apparent. In addition, the first retaining element 9 can be seen, which is designed as a brim and extends completely around the first molding 5. Moreover, a planar, flange-shaped first edge region 10 of the first molding is apparent.

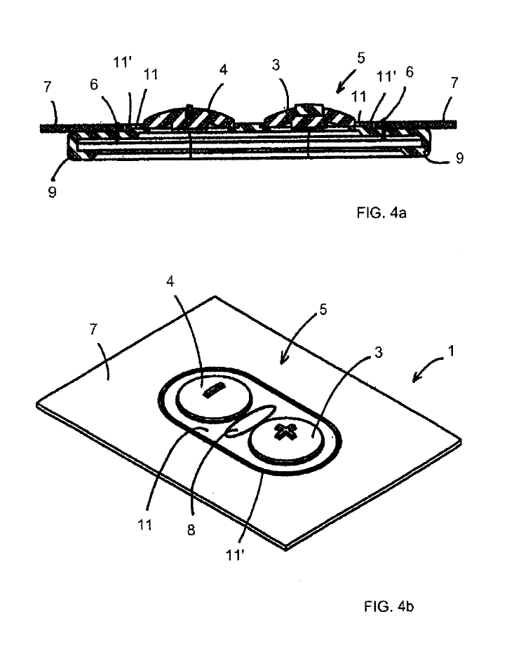

FIG. 4a shows a cross-section of the first molding 5 shown in FIGS. 2 and 3 in a schematic illustration. In this representation, the first brim-shaped retaining element 9 can be seen, as well as the flange-shaped edge region 10, one of the two operating elements 3, 4, and an outer shell 7 of an article of clothing 1 of the type that is proposed here, for example the glove shown in FIG. 1, and a seam 6, which rigidly connects the first molding 5 to the outer shell 7 of the article of clothing 1. As in the example shown in FIG. 1, the seam 6 extends around the operating elements 3, 4 as well as the transparent region (not visible here). The two operating elements and the transparent region are disposed on a carrier element 11 of the first molding 5, the element being raised as compared to the first edge region 10, so that a step 11′ having a height of approximately 1 mm is formed between the carrier element 11 and the first edge region 10, whereby the outer shell 7 of the article of clothing 1 ends flush with the carrier element 11. A recess 12 for accommodating a sealing element of the second molding is incorporated on a lower face of the first molding 5 directly beneath the carrier element 11, refer to FIGS. 5a and 5b.

FIG. 4b is another schematic illustration of the first molding 5 shown in FIG. 4a, this time in a view from obliquely above, wherein here it is especially apparent that the outer shell 7 of the article of clothing 1 (only sections of the latter can be seen here) ends flush with the carrier element 11 of the first molding 5 because of the step 11′ of the carrier element 11. The step 11′ of the carrier element 11 is also shown in FIG. 2.

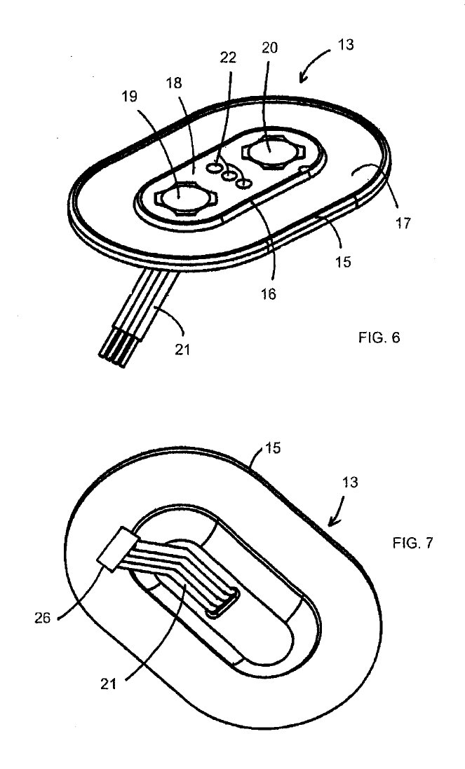

FIGS. 5a and 5b are schematic illustrations obliquely from above and oblique from beneath, respectively, of a second molding 13 of an operating part of an article of clothing of the type that is proposed here, for example the article of clothing 1 shown in FIG. 1, comprising a holder 14 for a control unit (which is not shown here, refer to FIG. 6) of a controllable device of the article of clothing. The holder 14 is designed as a depression in the second molding 13 and has a hole 25 in the bottom for passing control lines through the second molding, refer to FIG. 7. The second molding 13 additionally comprises a second retaining element 15, which is designed as the outer edge of the second molding 13 and extends completely around the same. A sealing element 16 in the form of a rib on the second molding 13 extends completely around the holder 14. The second molding 5 shown here is designed to match the first molding shown in FIGS. 2 to 4b and can be detachably connected thereto by bringing the first retaining element 9 of the first molding 5 into a positive-fit engagement with the second retaining element 15 of the second molding 13, refer to FIGS. 10a to 10c. The two retaining elements 9 and 15 are both produced from an elastic material, such as silicone, for example, so that they not only hold the two moldings 5 and 13 together, but also press them together, whereby the first flange-shaped edge region 10 of the first molding is in planar contact with a second flange-shaped edge region 17 and they are pressed against each other. The holder 14 of the control unit, around which the aforementioned two edge regions completely extend, is thus securely sealed. The sealing element 16 is further accommodated in the recess 12, whereby an additional sealing effect is achieved.

FIGS. 6 and 7 show schematic illustrations of the second molding shown in FIGS. 5a and 5b in a view obliquely from above and obliquely from beneath, a control unit 18 being now disposed in the holder 14 of the second molding 13. The control unit 18 comprises a first operating interface 19 and a second operating interface 20, which can be operated via the first and/or second operating elements 3, 4 of the first molding 5 as soon as the two moldings are connected to each other, refer to FIGS. 10a to 10c. Also apparent are four electrical control lines 21, which are passed through the hole 25 in the second molding, as is shown in FIG. 7. The control unit 18 further comprises a display 22 for displaying an operating or control state of the control unit as a function of a control parameter set by means of the operating interfaces 19, 20. In the present example, this is provided by a heating output of a controllable heating device which can be connected to the control unit, for example the heating device 24 shown in FIG. 1.

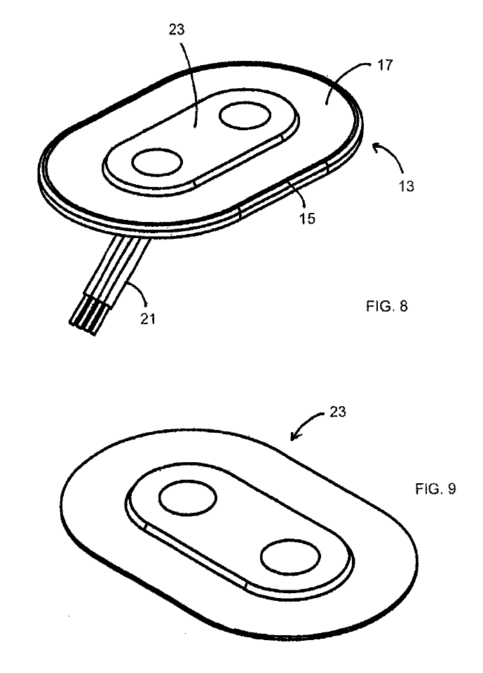

FIG. 8 shows the second molding 13 shown in FIGS. 6 and 7 with a protective cover 23, which is produced from transparent silicone and closes the holder 14 with the control unit 18 contained in the holder 14, and thus protects the control unit from outside influences as long as the second molding 13 is not connected to the first molding 5. FIG. 9 shows this protective cover again in a detailed view, wherein a first end of the control line is connected to the control unit 18 and the second end comprises a plug device 26 for connection to a controllable device.

FIGS. 10a to 10c show the two moldings 5 and 13 of the previous FIGS. 2 and 8 separately (FIG. 10a and FIG. 10b) and connected to each other (FIG. 10c) in schematic illustrations. It is apparent that the two operating interfaces 19 and 20 of the control unit are located directly beneath the two operating elements 3 and 4 of the first molding and thus can be operated manually via the two operating elements 3 and 4. It is also apparent that the brim-shaped first retaining element 9 latches completely over the second retaining element 15, which is to say over the outer edge of the second molding 13, and thus positively connects the first molding 5 to the second molding 13. The two moldings 5 and 13 are thus additionally pressed against each other by means of the two retaining elements 9 and 15.

### LIST OF REFERENCE NUMERALS

1 Article of clothing
2 Operating part
3 First operating element
4 Second operating element
5 First molding
6 Seam
7 Outer shell of the article of clothing
8 Transparent region
9 First retaining element
10 First edge region
11 Carrier element
12 Recess
13 Second molding
14 Holder
15 Second retaining element
16 Sealing element
17 Second edge region
18 Control unit
19 First operating interface
20 Second operating interface
21 Control line
22 Display
23 Protective cover
24 Controllable device
25 Hole for control line

What is claimed is:

1. An article of clothing, comprising an operating part for manually operating a controllable device which can be connected to the article of clothing by means of at least one operating element of the operating part, wherein the operating part comprises a first molding, which is rigidly connected to the article of clothing and which comprises the at least one operating element, and a second molding, which comprises a holder for a control unit of the device and can be connected to the first molding, wherein the first molding comprises at least one retaining element, and the second molding comprises at least one second retaining element, wherein the two retaining elements can be brought into mutual engagement so as establish a detachable connection between the first molding and the second molding.

2. The article of clothing according to claim 1, wherein one of the at least one first retaining element is designed as a brim extending completely around the first molding or that one of the at least one second retaining element is designed as a brim extending completely around the second molding.

3. An article of clothing according to claim 1, wherein one of the at least one first retaining elements is designed as an outer edge of the first molding or that one of the at least one second retaining elements is designed as an outer edge of the second molding.

4. An article of clothing according to claim 1, wherein the holder for the control unit is a depression in the second molding.

5. An article of clothing according to claim 1, wherein the holder is covered by a protective film or a protective cover.

6. An article of clothing according to claim 1, wherein the first molding has a flange-shaped first edge region and the second molding has a flange-shaped second edge region, wherein the first edge region and the second edge region rest on top of each other in a planar manner and extend completely around the holder when the two moldings are connected to each other by mutual engagement of the two retaining elements.

7. An article of clothing according to claim 1, wherein the first molding and/or the second molding are produced from a flexible plastic material, and more particularly from silicone.

8. An article of clothing according to claim 1, wherein the second molding has a hole for passing electrical wires through the second molding.

9. An article of clothing according to claim 1, wherein the first molding and/or the second molding comprise a sealing element which extends completely around the holder and seals the same when the two moldings are connected to each other by mutual engagement of the two retaining elements.

10. An article of clothing according to claim 1, wherein the first molding is designed to be transparent at least regionally so as to render a display of the control unit visible.

11. An article of clothing according to claim 1, wherein the article of clothing comprises a device which is connected to the article of clothing and a control unit for controlling the device, wherein the control unit is disposed in the holder of the second molding.

12. The article of clothing according to claim 11, wherein the control unit comprises a control line for transmitting control signals to the device, wherein the control line is passed through the second molding through a hole in the second molding and can be connected to the device.

13. The article of clothing according to claim 11, wherein the control unit comprises at least one input interface for manually inputting control parameters in the control unit, wherein the at least one input interface can be operated by means of the at least one input element of the first molding when the two moldings are connected to each other.

14. The article of clothing according to claim 12, wherein the control unit comprises at least one input interface for manually inputting control parameters in the control unit, wherein the at least one input interface can be operated by means of the at least one input element of the first molding when the two moldings are connected to each other.

15. The article of clothing according to claim 11, wherein the article of clothing is a jacket, pants, a glove, a shoe, a sock, a cap or a part of such an article of clothing.

16. The article of clothing according to claim 12, wherein the article of clothing is a jacket, pants, a glove, a shoe, a sock, a cap or a part of such an article of clothing.

17. The article of clothing according to claim 13, wherein the article of clothing is a jacket, pants, a glove, a shoe, a sock, a cap or a part of such an article of clothing.

18. The article of clothing according to claim 11, wherein the device comprises a heating device for the article of clothing.

19. The article of clothing according to claim 12, wherein the device comprises a heating device for the article of clothing.

20. The article of clothing according to claim 13, wherein the device comprises a heating device for the article of clothing.

21. The article of clothing according to claim 14, wherein the device comprises a heating device for the article of clothing.
